(19) United States
(12) Patent Application Publication
(10) Pub. No.: US 2025/0122940 A1
(43) Pub. Date: Apr. 17, 2025

(54) Check Valve for Refrigeration Systems

(71) Applicant: Parker-Hannifin Corporation, Cleveland, OH (US)

(72) Inventor: Manish P. Patel, Martin, TN (US)

(21) Appl. No.: 18/911,373

(22) Filed: Oct. 10, 2024

Related U.S. Application Data
(60) Provisional application No. 63/589,406, filed on Oct. 11, 2023.
(60) Provisional application No. 63/566,814, filed on Mar. 18, 2024.

(51) Int. Cl. F16K 15/02; B23P 19/04

(52) U.S. Cl. CPC F16K 15/025; B23P 19/04

(57) ABSTRACT

An example assembly includes: a tube having a first port and a second port; a sleeve fixedly disposed within the tube; a stem disposed, and axially movable, within the sleeve, wherein the stem has a rim formed at a proximal end thereof; a spring mounted around the stem and axially interposed between the sleeve and the rim of the stem; and a seal mounted to the stem. Refrigerant received at the first port pushes the stem in a distal direction, compressing the spring, thereby preventing the stem from moving in the distal direction beyond a particular axial position, while allowing refrigerant to flow to the second port. As pressure level at the first port is reduced, the spring pushes the stem in a proximal direction until the seal reaches the sleeve, thereby preventing the stem from moving further in the proximal direction, and blocking refrigerant flow to the first port.

### CROSS REFERENCE TO RELATED APPLICATION

The present application claims priority to U.S. Provisional Application No. 63/589,406, filed on Oct. 11, 2023, and U.S. Provisional Application No. 63/566,814, filed on Mar. 18, 2024, the entire contents of all of which are herein incorporated by reference as if fully set forth in this description.

### BACKGROUND

The heating, ventilation, air conditioning, and refrigeration (HVACR) industry is moving toward using environment-friendly refrigerants. For example, new refrigerants having lower flammability and toxicity are being used. Such refrigerants are typically designated as A2L refrigerants, where “A” indicates non-toxicity, “2” indicates low/mild flammability, and “L” indicates low burning velocity. Refrigeration systems using A2L refrigerants may require an isolation safety valve, e.g., a check valve, that blocks flow in a certain direction as required.

Conventional check valves include components positioned into a body. Containing such components in the body may require a joining feature such as two shells that are welded together or a tube with two end caps welded together. This may also require painting for corrosion protection if steel is used. These processes might not be efficient and may cause leaks to occur.

Further, some conventional check valves include a ball configured to be pushed against a seat to block flow in a certain direction. For example, a steel ball may be seated at a brass seat to block flow. However, such configuration allows a certain leak rate across the seat, which might not be desirable.

It may thus be desirable to provide an enhanced check valve that prevents leakage and that is made using an efficient, more robust manufacturing process. It is with respect to these and other considerations that the disclosure made herein is presented.

### SUMMARY

The present disclosure describes implementations that relate to a check valve for refrigeration systems.

In a first example implementation, the present disclosure describes an assembly. The assembly includes: a tube having a first port and a second port; a sleeve fixedly disposed within the tube; a stem disposed, and axially movable, within the sleeve, wherein the stem has a rim formed at a proximal end thereof; a spring mounted around the stem and axially interposed between the sleeve and the rim of the stem; and a seal mounted to the stem. Refrigerant received at the first port pushes the stem in a distal direction, compressing the spring, thereby preventing the stem from moving in the distal direction beyond a particular axial position, while allowing refrigerant to flow to the second port. As pressure level at the first port is reduced, the spring pushes the stem in a proximal direction until the seal reaches the sleeve, thereby preventing the stem from moving further in the proximal direction, and blocking refrigerant flow to the first port.

In a second example implementation, the present disclosure also describes a method of forming the assembly of the first example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1A illustrates a perspective cross-sectional view of an assembly of a check valve mounted inside a tube in an open state, according to an example implementation.

FIG. 1B illustrates a cross-sectional side view of the assembly of FIG. 1A, according to an example implementation.

FIG. 2 illustrates a perspective view of a sleeve of the check valve of FIGS. 1A-1B, according to an example implementation.

FIG. 3 illustrates a perspective view of a stem of the check valve of FIGS. 1A-1B, according to an example implementation.

FIG. 4 illustrates a perspective of the check valve of FIGS. 1A-1B including a stem mounted through a sleeve and translated in a distal direction to be in an open state, according to an example implementation.

FIG. 5 illustrates another perspective of the check valve of FIGS. 1A-1B with the stem translated in a proximal direction to be in a closed state, according to an example implementation.

FIG. 6A illustrates a perspective cross-sectional view of the assembly of FIGS. 1A-1B in a closed state, according to an example implementation.

FIG. 6B illustrates a cross-sectional side view of the assembly of FIG. 6A, according to an example implementation.

FIG. 7A illustrates a perspective cross-sectional view of an assembly of a check valve mounted inside a tube in a closed state, according to an example implementation.

FIG. 7B illustrates a perspective cross-sectional view of the assembly of FIG. 7A in an open state, according to an example implementation.

FIG. 8 is a flowchart of a method of making the assembly of FIGS. 1A-1B, FIGS. 6A-6B, and FIGS. 7A-7B, according to an example implementation.

### DETAILED DESCRIPTION

Within examples, disclosed herein is a check valve mounted within a tube having a first port and a second port. The check valve includes a sleeve fixedly disposed within the tube and a stem disposed, and axially movable, within the sleeve. The stem has a rim formed at a proximal end thereof and includes an annular groove in which a seal is mounted to the stem.

In an example, a spring can be mounted to the stem, resting between the fixed sleeve and the rim of the stem. Refrigerant received at the first port can push the stem in a distal direction, compressing the spring. The spring can thus prevent the stem from moving in the distal direction beyond a particular position. In this state, the stem is in an open position allowing refrigerant to flow to the second port.

When pressure level at the first port is relieved or reduced, the spring facilitates pushing the stem back in a proximal direction until the seal reaches the sleeve, thereby preventing the stem from moving further in the proximal direction. In this state, the stem is in a closed position blocking refrigerant flow to the first port. The terms “refrigerant” and “fluid” are used interchangeably throughout herein.

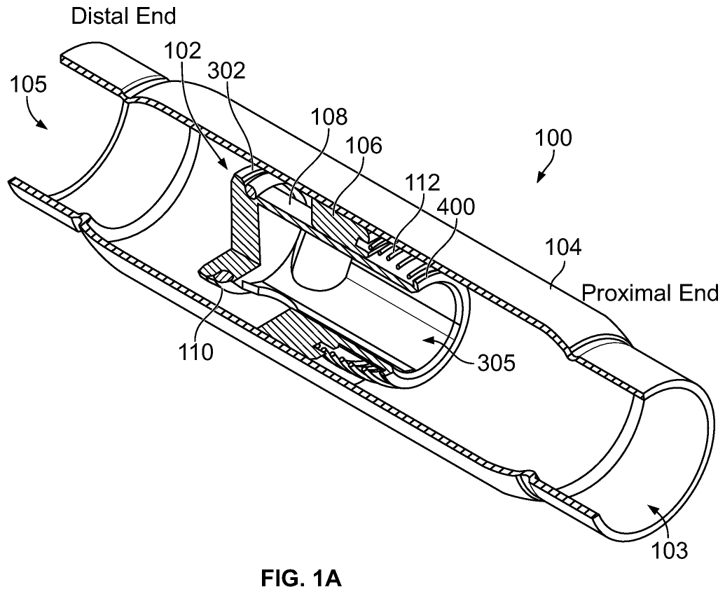

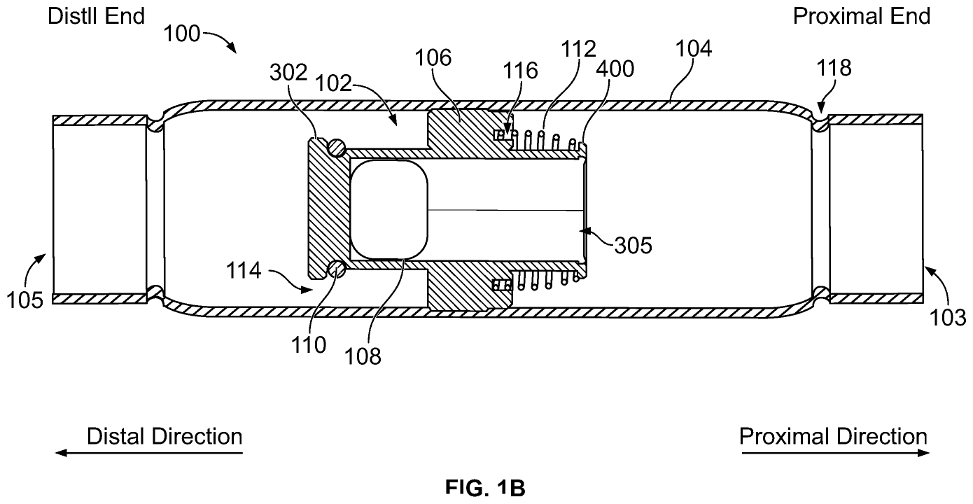

FIG. 1A illustrates a perspective cross-sectional view of an assembly 100 of a check valve 102 mounted inside a tube 104 in an open state, and FIG. 1B illustrates a cross-sectional side view of the assembly 100 in the open state, according to an example implementation. FIGS. 1A-1B are described together.

The tube 104 can be made of refrigerant grade copper, for example. The tube 104 defines or includes a first port 103 at its proximal end and a second port 105 at its distal end.

The check valve 102 includes a sleeve 106, a stem 108, and a seal 110 (e.g., an O-ring radial seal) mounted to the stem 108. The sleeve 106 is fixedly positioned within the tube 104, while the stem 108 and the seal 110 mounted thereto are axially movable, e.g., the stem 108 can slide within the sleeve 106. In an example, components of the check valve 102 (i.e., the sleeve 106 and the stem 108) can be made of brass (e.g., 360 round stock brass). In one example, the seal 110 can be an O-ring made from neoprene.

In an example, the check valve 102 can further include a spring 112. As described in more detail below, the spring 112 may facilitate returning the stem 108 to a closed position when pressure at the first port 103 is relieved or reduced.

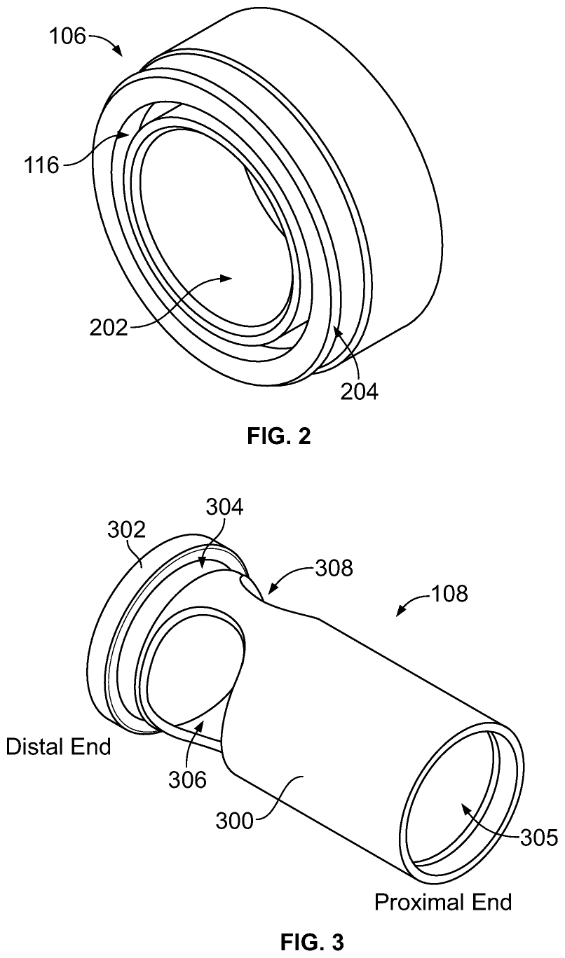

FIG. 2 illustrates a perspective view of the sleeve 106, according to an example implementation. The sleeve 106 is generally cylindrical in shape as depicted. Particularly, the sleeve 106 is configured as a hollow cylinder having a cylindrical cavity 202 formed therein to receive the stem 108 therethrough.

As mentioned above, the sleeve 106 if fixedly mounted into the tube 104. For example, the sleeve 106 can be inserted from the distal end of the tube 104, and can be press fitted into the tube 104 to be fixedly disposed therein. In an example, the sleeve 106 has a tapered end 204 configured as a lead-in chamfer machined in the sleeve 106 to facilitate inserting and press fitting the sleeve 106 into the tube 104 without causing burrs or rough finishes.

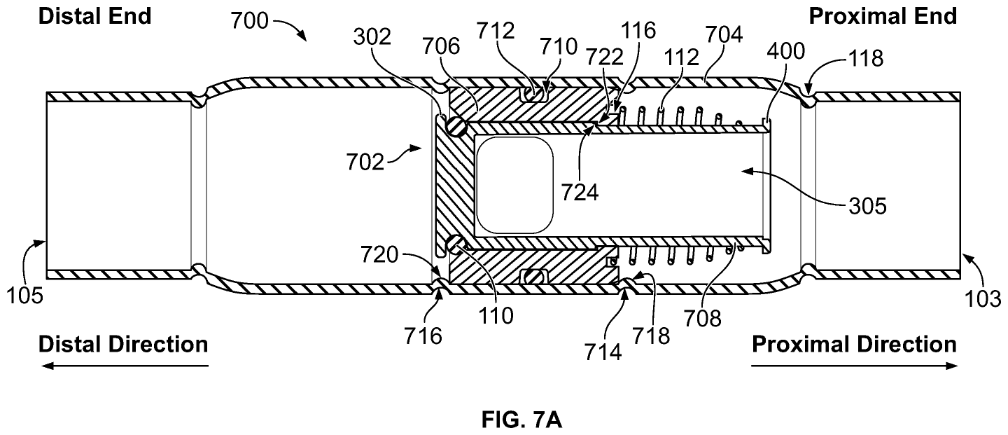

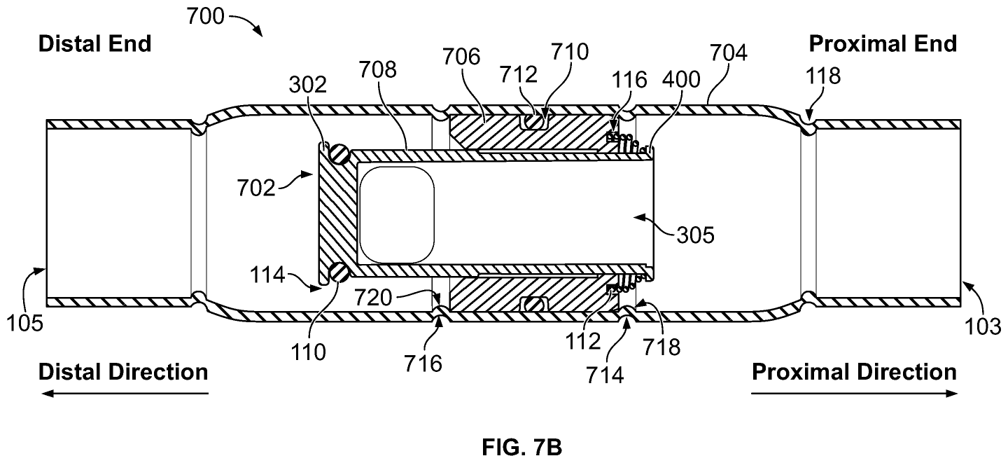

Other techniques could be used to fixedly position the sleeve 106 within the tube. For example, barbs can be used. In another example, as described below with respect to FIGS. 7A-7B, the sleeve 106 can be inserted to a particular position within the tube 104, and then grooves are made into the tube 104 on both sides of the sleeve 106, thereby forming internal shoulders or protrusions that retain the sleeve 106 in position.

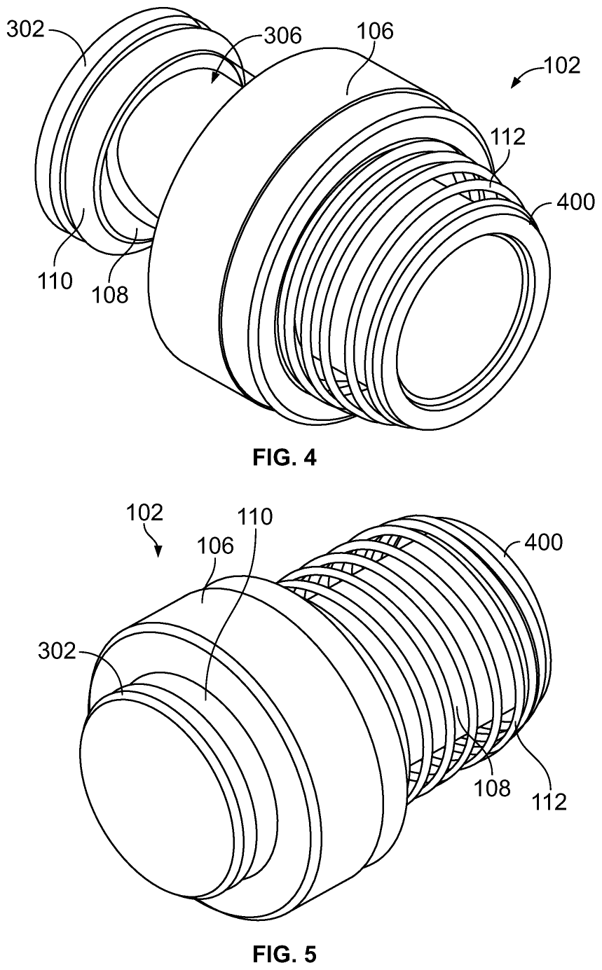

FIG. 3 illustrates a perspective view of the stem 108 of the check valve 102, according to an example implementation. The stem 108 is generally cylindrical as depicted. Particularly, the stem 108 has a cylindrical portion 300, a flanged distal end 302, and an annular groove 304 formed or interposed between the cylindrical portion 300 and the flanged distal end 302. An outer diameter of the flanged distal end 302 of the stem 108 is smaller than the inner diameter of the tube 104 such that an annular gap 114 shown in FIG. 1B is formed between the flanged distal end 302 and the tube 104 to allow fluid flow therethrough as described below.

The stem 108 is partially hollow, having a blind cavity 305 that allows fluid flow therethrough. The stem 108 also includes one or more windows, holes or slots, such as circumferential slot 306 and circumferential slot 308, machined laterally in the cylindrical portion 300 of the stem 108.

FIG. 4 illustrates a perspective of the check valve 102 including the stem 108 mounted through the sleeve 106 and translated in a distal direction to be in an open state, and FIG. 5 illustrates another perspective of the check valve 102 with the stem 108 translated in a proximal direction to be in a closed state, according to an example implementation. As shown in FIG. 4, after the stem 108 is mounted through the sleeve 106, and the spring 112 is mounted around the stem 108, a proximal end of the stem 108 is made into a rim 400 (e.g., an edge, border, or lip projecting outward to form an enlarged diameter rim).

As an example, the rim 400 can be made via a roll forming process. For instance, as the check valve 102 can be positioned in the closed state shown in FIG. 5 such that the proximal end of the stem 108 protrudes from the proximal end of the sleeve 106. A tool can then be used to compress the proximal end of the stem 108. The tool can include a rotating head and a hammer-like instrument, for example, used to compress the proximal end of the stem 108 to form the rim 400. Other manufacturing technique (e.g., milling) can be used for form the rim 400.

Referring to FIGS. 1A-1B, 4-5 together, the spring 112 is interposed axially between the rim 400 and the sleeve 106. Particularly, a proximal end of the spring 112 rests on the rim 400, while a distal end of the spring 112 rests on the sleeve 106. With this configuration, the spring 112 biases or applies a biasing force on the stem 108 in the proximal direction.

In an example, the sleeve 106 can include an annular groove 116 formed in the proximal end of the sleeve 106 as shown in FIG. 1B. The distal end of the spring 112 is received within the annular groove 116 to help aligning, mounting, and retaining the spring 112.

In an example, as shown in the example implementation of FIG. 1B, the spring 112 can be configured as a conical spring that is coiled in increasing outer diameter in the distal direction. In other words, the spring 112 is tapered and has the shape of a cone such that coils closer to the rim 400 have a smaller diameter compared to coils closer to the sleeve. With this configuration, the spring 112 can apply a particular desired spring force at a reduced solid height compared to a non-conical spring, and may provide enhanced stability.

When the stem 108 moves in the distal direction, it compresses the spring 112. The spring 112 can thus prevent the stem 108 from moving in the distal direction beyond a particular axial position (e.g., when the spring 112 reaches its solid height). In an example where the check valve 102 does not include the spring 112, the rim 400 interacts with the proximal end of the sleeve 106 to prevent the stem 108 from moving in the distal direction beyond a certain position.

Referring to FIG. 1B, 5 together, if pressure at the first port 103 is reduced such that fluid force cannot overcome the biasing force of the spring 112 on the stem 108, the stem 108 can move in the proximal direction via the spring 112 until the seal 110 reaches the distal end of the sleeve 106. The stem 108 cannot move further in the proximal direction beyond the position shown in FIG. 5.

With this configuration, the stem 108 is allowed to slide within the sleeve 106 while being retained in both directions. Particularly, the spring 112 cannot be compressed beyond a certain position, preventing the stem 108 from moving in the distal direction beyond a particular position. On the other hand, the flanged distal end 302 and the seal 110 prevent the stem 108 from moving in the proximal direction further than the position shown in FIG. 5.

To form the assembly 100, the tube 104 may be first provided with its proximal and distal ends having the full inner diameter (i.e., before forming other geometric features at the distal or proximal end of the tube 104). The check valve 102 can be assembled prior to insertion into the tube 104. Particularly, the stem 108 can be slid through the sleeve 106, the spring 112 can be mounted around the stem 108, and then the proximal end of the stem 108 is roll formed to construct the rim 400. The spring 112 can thus be axially interposed and retained between the rim 400 and the sleeve 106 (e.g., the annular groove 116). Thereafter, the seal 110 (e.g., O-ring) can be lubricated and mounted around the annular groove 304 of the stem 108.

The check valve 102 can then be inserted into the tube 104 such that the sleeve 106 is pressed into the tube 104, with the tapered end 204 (see FIG. 2) facilitating insertion of the sleeve 106 into the tube 104. As an alternative to press or interference fitting, the sleeve 106 can be positioned at a particular axial position within the tube 104, and the tube 104 can then be machined to form internal shoulders that retain the sleeve 106. The proximal and distal ends of the tube 104 can then be further machined or processed to form any required features thereat.

In an example, the tube 104 can be machined using a friction spinning process. Such process may involve the use of process elements from both metal spinning and friction welding. As the tube 104 is processed, friction sub-processes are employed to achieve self-induced heat generation. This in-process heat treatment allows complex geometries to be achieved.

For example, the tube 104 can be provided where the tube 104 has a fixed inner diameter and outer diameter throughout its length. Components of the check valve 102 can then be inserted into the tube 104. Further processing is then implemented at the tube 104 to complete the assembly 100.

For example, the tube 104 can be held firmly in place. A friction spinning machine may have a head that is positioned to interface with and machine the outer surface of the tube 104 at its proximal end, for example. The machine can also have a pin that is inserted into the tube 104 to interface with and machine the interior surface of the tube 104.

The head and the pin can then be spun at a high speed, e.g., a 1000 revolution per minute (rpm). The head can have a spherical or conical shape, for example, to machine or grind the proximal end of the tube 104 to have a respective coupling features, e.g., to machine the proximal end to a particular shape as specified or as appropriate for connecting with the refrigeration system. For example, the outer diameter can be machine to a specific diameter, a neck can be formed such as neck 118 shown in FIG. 1B, respective coupling features such as threads can then be machined, etc. The head can thus grind and melt the metal (e.g., copper or brass) of the tube 104 to shape it as desired.

At the same time, the pin machines the interior surface to a particular inner diameter as desired. In an example, while the head and the pin machine the end of the tube 104, nitrogen gas may be blown over the tube 104 being machined to keep it clean. After machining is completed, the head and pin can be withdrawn, and the blowing nitrogen gas cools the tube 104 and solidifies it in the shape.

This process can be repeated at the distal end of the tube 104 such that both ends have respective coupling features (e.g., threads and a particular shape appropriate for connecting to a fitting). In examples, both ends of the tube 104 can be machined at the same time. The assembly 100 can now be mounted in a refrigeration system (e.g., refrigerant lines such as pipes or hoses can be connected to the tube 104). Advantageously, this manufacturing process may be efficient compared to conventional methods involving welding components together, which can lead to rusting, potential leakage, higher cost, etc.

Referring to FIGS. 1A-1B, during operation of the assembly 100 in a refrigeration system, the stem 108 slides back and forth based on flow direction. The assembly 100 allows fluid flow from the first port 103 to the second port 105, while blocking fluid flow from the second port 105 to the first port 103.

Fluid received at the first port 103 can flow through the blind cavity 305 of the stem 108 pushing the stem 108 in the distal direction, compressing the spring 112 as shown in FIGS. 1A-1B. Fluid flows from the blind cavity 305 radially or laterally outward through the circumferential slots 306, 308, then around the flanged distal end 302 of the stem 108 through the annular gap 114 (between the flanged distal end 302 and the interior surface of the tube 104), and is then discharged through the second port 105.

When refrigerant pressure level at the first port 103 is reduced or when flow direction is reversed, the spring 112 pushes the stem 108 back in the proximal direction. This way, the check valve 102 closes and blocks any flow from the second port 105 to the first port 103.

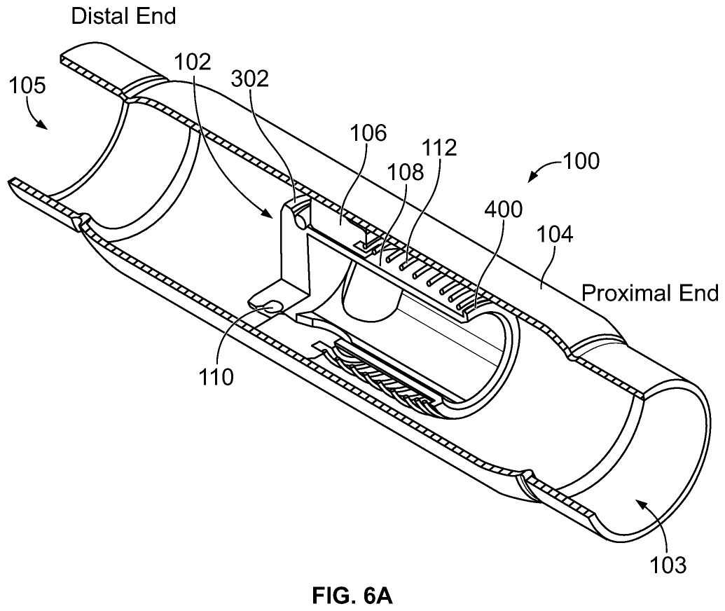

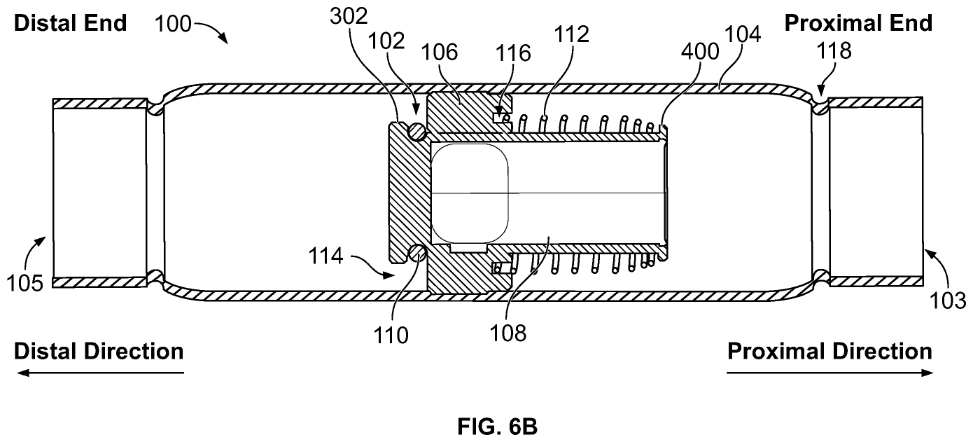

FIG. 6A illustrates a perspective cross-sectional view of the assembly 100 in a closed state, and FIG. 6B illustrates a cross-sectional side view of the assembly 100 in the closed state, according to an example implementation. FIGS. 6A-6B are described together.

As shown in FIGS. 6A-6B, when flow direction is reversed (i.e., refrigerant is received at the second port 105) or the pressure level at the first port 103 is not sufficient to overcome the spring 112, the spring 112 pushes the stem 108 in the proximal direction until the seal 110 reaches and seals against a distal end of the sleeve 106 (see FIG. 5), thereby blocking fluid flow from the second port 105 to the first port 103. Using the seal 110, the check valve 102 enhances sealing (e.g., substantially zero leakage) compared to conventional configurations where a ball is configured to be pushed against a seat to block flow in a certain direction as such configuration is prone to allow a certain leak rate across the seat.

Other variations to the configurations shown in FIGS. 1-6B can be implemented. For example, as mentioned above, rather than press fitting the sleeve 106 into the tube 104, other retention techniques and features can be used.

FIG. 7A illustrates a perspective cross-sectional view of an assembly 700 of a check valve 702 mounted inside a tube 704 in a closed state, and FIG. 7B illustrates a perspective cross-sectional view of the assembly 700 of the check valve 702 mounted inside the tube 704 in an open state, according to an example implementation. The assembly 700 is generally similar to the assembly 100 with additional features. Similar features and components between the assembly 100 and the assembly 700 are designated with the same reference numbers.

The check valve 702 is similar to the check valve 102 and includes a sleeve 706, a stem 708, and the seal 110 (e.g., an O-ring radial seal) mounted to the stem 708. Similar to the sleeve 106, the sleeve 706 is fixedly positioned within the tube 704, while the stem 708 and the seal 110 mounted thereto are axially movable, e.g., the stem 708 can slide within the sleeve 706. The check valve 702 also includes the spring 112 to facilitate returning the stem 708 to a closed position when pressure at the first port 103 is relieved or reduced.

The sleeve 706 differs from the sleeve 106 in that the sleeve 706 is longer to accommodate an annular groove 710 formed in the exterior surface of the sleeve 706. Further, the check valve 702 includes an additional or second seal 712 (e.g., an O-ring radial seal) mounted in the annular groove 710 to form a seal between an exterior surface of the sleeve 706 and an interior surface of the tube 704, preventing bypass leakage.

Further, rather than having an interference fit between the sleeve 706 and the tube 704 and press fitting the sleeve 706 into the tube 704, another technique may be used. Particularly, the sleeve 706 may have an outer diameter that is slightly less than an inner diameter of the tube 704 such that there is a slight loose fit when the sleeve 706 is inserted into the tube 704.

Once the sleeve 706 is inserted to a particular desired position, two grooves are roll-formed into the tube 704 to form stops that retain the sleeve 706 in position. Particularly, a proximal annular groove 714 can be roll-formed into the tube 704 on a proximal side of the sleeve 706, and similarly a distal annular groove 716 can be roll-formed into the tube 704 on a distal side of the sleeve 706.

As a result of forming the proximal annular groove 714, an internal annular protrusion 718 is formed and operates as a stop retaining the sleeve 706 in the proximal direction. Similarly, as a result of forming the distal annular groove 716, an internal annular protrusion 720 is formed and operates as a stop retaining the sleeve 706 in the distal direction. This way, the sleeve 706 is retained axially within the tube 704.

Further, when the spring 112 returns the stem 708 to the closed position shown in FIG. 7A, the seal 110 interfaces with the distal end of the sleeve 706 as shown. To prevent the seal 110 from shearing or being damaged under pressured, the sleeve 706 has an internal shoulder 722, and the stem 708 has a corresponding external shoulder 724. When the stem 708 is pushed in the proximal direction via the spring 112, the external shoulder 724 of the stem 708 reaches the internal shoulder 722 of the sleeve 706. The internal shoulder 722 operates as a dead stop for the stem 708, thereby preventing the stem 708 from moving further in the proximal direction, while reducing the load on the seal 110 and preventing it from being damaged.

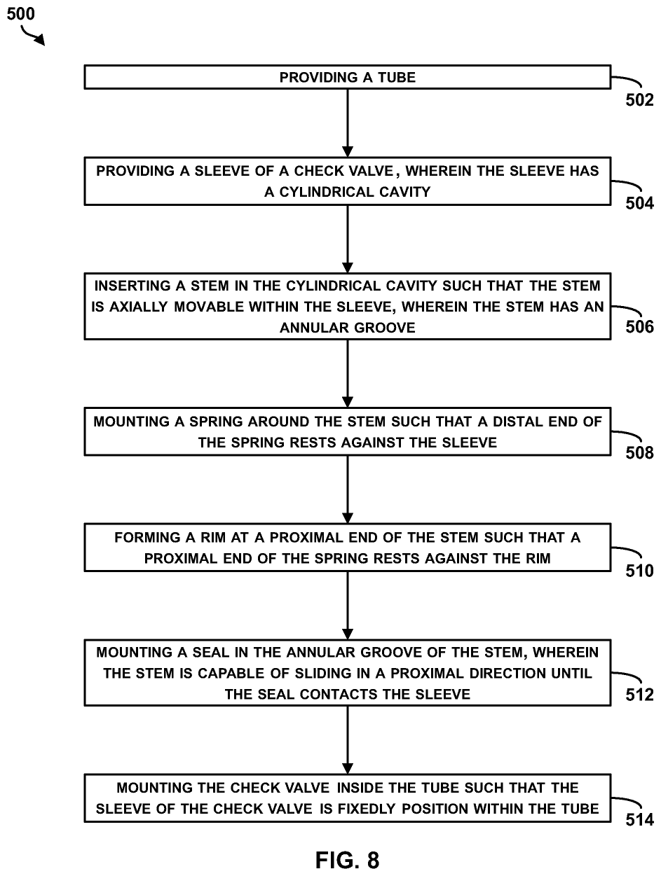

FIG. 8 is a flowchart of a method 500 of making the assembly 100, according to an example implementation. The method 500 may include one or more operations, functions, or actions as illustrated by one or more of blocks 502-510. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 502, the method 500 includes providing the tube 104, 704. The term “providing” as used herein, and for example with regard to the tube 104, 704 or other components, includes any action to make the tube 104, 704 or any other component available for use, such as bringing the tube 104, 704 or other component to an apparatus or to a work environment for further processing (e.g., mounting the stem 108, 708 inside the sleeve 106, 706 mounting the check valve 102, 702 inside the tube 104, 704, further processing/machining of the tube 104, 704, etc.).

At block 504, the method 500 includes providing the sleeve 106, 706 of the check valve 102, 702 wherein the sleeve 106, 706 has a cylindrical cavity (e.g., the cylindrical cavity 202).

At block 506, the method 500 includes inserting the stem 108, 708 in the cylindrical cavity 202 such that the stem 108, 708 is axially movable within the sleeve 106, 706, wherein the stem 108, 708 has the annular groove 304.

At block 508, the method 500 includes mounting the spring 112 around the stem 108, 708 such that a distal end of the spring 112 rests against the sleeve 106, 706.

At block 510, the method 500 includes forming the rim 400 at a proximal end of the stem 108, 708 such that a proximal end of the spring 112 rests against the rim 400.

At block 512, the method 500 includes mounting the seal 110 in the annular groove 304 of the stem, wherein the stem 108, 708 is capable of sliding in a proximal direction until the seal 110 contacts the sleeve 106, 706. As mentioned above, the sleeve 706 can have the internal shoulder 722, and the stem 708 can have the external shoulder 724, and when the stem 708 is pushed in the proximal direction via the spring 112, the external shoulder 724 of the stem 708 reaches the internal shoulder 722 of the sleeve 706, thereby preventing the stem 708 from moving further in the proximal direction, while reducing the load on the seal 110 and preventing it from being damaged.

At block 514, the method 500 includes mounting the check valve 102, 702 inside the tube 104, 704 such that the sleeve 106, 706 of the check valve 102, 702 is fixedly position within the tube 104, 704.

The method 500 can further include any of the other steps or operations described throughout herein.

For example, inserting the stem 108, 708 in the cylindrical cavity 202 of the sleeve 106, 706 can include: inserting the cylindrical portion 300 of the stem 108, 708 in the cylindrical cavity 202 of the sleeve 106, 706 wherein the stem 108, 708 further includes the flanged distal end 302, wherein the annular groove 304 is interposed between the cylindrical portion 300 and the flanged distal end 302.

In an example, the method further includes forming the stem 108, 708 to have the blind cavity 305 and one or more circumferential slots (e.g., the circumferential slots 306, 308) in the cylindrical portion 300.

In an example, the sleeve 106, 706 has the tapered end 204, wherein mounting the check valve 102, 702 inside the tube 104, 704 includes inserting the sleeve 106, 706 into the tube 104, 704, wherein the tapered end 204 operates as a lead-in chamfer that facilitates insertion of the sleeve 106, 706 into the tube 104, 704.

The method can also include forming the flanged distal end 302 of the stem 108, 708 such that an outer diameter of the flanged distal end 302 is smaller than an inner diameter of the tube 104, 704 (to form the annular gap 114).

In an example, mounting the check valve 102 inside the tube 104 can include press fitting the sleeve 106 into the tube 104 (e.g., via an interference fit between the sleeve 106 and the tube 104). In another example, rather than press fitting, the sleeve 706 can be positioned within the tube 704 via a loose fit, and the annular grooves 714, 716 are formed to retain the sleeve 706 in position. As mentioned above, the method can further include forming the annular groove 710 in the sleeve 706 to place the seal 712 therein.

In an example, the method can further include forming the annular groove 116 in the proximal end of the sleeve 106, wherein mounting the spring 112 around the stem 108, 708 includes causing a distal end of the spring 112 to be received in the annular groove 116 of the sleeve 106, 706.

In one example, mounting the spring 112 includes mounting a conical spring coiled in increasing outer diameter in a distal direction such that coils closer to the rim 400 have a smaller diameter compared to coils closer to the sleeve 106, 706.

As mentioned above, in an example, the method can further include, after mounting the check valve 102, 702 within the tube 104, 704, forming respective coupling features (the neck 118, threads, etc.) in a proximal end and a distal end of the tube 104, 704 to facilitate coupling the tube 104, 704 to a refrigeration system.

In one example, forming the respective coupling features includes using friction spinning to form the respective coupling features.

In an example, forming the respective coupling features includes forming the neck 118 at the proximal end of the tube 104, 704.

In another example, forming the respective coupling features includes threads at the proximal end of the tube 104, 704 (to facilitate coupling the tube 104, 704 to a fitting, manifold, etc.).

In one example, forming the rim 400 includes using a rolling forming process to form the rim 400.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform actuators presented in the figures. In some instances, components of the devices and/or systems may be configured to perform the actuators such that the components are actually configured and structured (with hardware and/or software) to enable such performance. In other examples, components of the devices and/or systems may be arranged to be adapted to, capable of, or suited for performing the actuators, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.
EEE 1 is an assembly comprising: a tube having a first port and a second port; a sleeve fixedly disposed within the tube; a stem disposed, and axially movable, within the sleeve, wherein the stem has a rim formed at a proximal end thereof; a spring mounted around the stem and axially interposed between the sleeve and the rim of the stem; and a seal mounted to the stem, wherein: refrigerant received at the first port pushes the stem in a distal direction, compressing the spring, thereby preventing the stem from moving in the distal direction beyond a particular axial position, while allowing refrigerant to flow to the second port, and as pressure level at the first port is reduced, the spring pushes the stem in a proximal direction until the seal reaches the sleeve, thereby preventing the stem from moving further in the proximal direction, and blocking refrigerant flow to the first port.
EEE 2 is the assembly of EEE 1, wherein the stem has a cylindrical portion, a flanged distal end, and an annular groove interposed between the cylindrical portion and the flanged distal end, wherein the seal is mounted in the annular groove.
EEE 3 is the assembly of EEE 2, wherein the stem has a blind cavity and one or more circumferential slots formed in the cylindrical portion, wherein refrigerant received at the first port flows through the blind cavity, pushing the stem in the distal direction, then laterally outward through the one or more circumferential slots, then around the flanged distal end to the second port.
EEE 4 is the assembly of EEE 3, wherein the sleeve comprises a tapered end that facilitates inserting.
EEE 5 is the assembly of any of EEEs 3-4, wherein an outer diameter of the flanged distal end is smaller than an inner diameter of the tube such that refrigerant discharged from the one or more circumferential slots flows through an annular gap formed between the flanged distal end and the tube.
EEE 6 is the assembly of any of EEEs 1-5, wherein the sleeve has an annular groove formed in a proximal end of the sleeve, wherein a proximal end of the spring rests on the rim, while a distal end of the spring is received in the annular groove of the sleeve.
EEE 7 is the assembly of any of EEEs 1-6, wherein the spring is a conical spring coiled in increasing outer diameter in the distal direction such that coils closer to the rim have a smaller diameter compared to coils closer to the sleeve.
EEE 8 is the assembly of any of EEEs 1-7, wherein the seal is a first seal, wherein the sleeve has an annular groove, and wherein the assembly further comprises: a second seal disposed in the annular groove of the sleeve such that the second seal is configured to seal between an exterior surface of the sleeve and an interior surface of the tube.
EEE 9 is the assembly of any of EEEs 1-8, wherein the tube further comprises: a proximal annular groove formed on a proximal side of the sleeve; and a distal annular groove formed on a distal side of the sleeve, wherein the proximal annular groove and the distal annular groove form respective internal annular protrusions that retain the sleeve axially within the tube.
EEE 10 is a method comprising: providing a tube; providing a sleeve of a check valve, wherein the sleeve has a cylindrical cavity; inserting a stem in the cylindrical cavity such that the stem is axially movable within the sleeve, wherein the stem has an annular groove; mounting a spring around the stem such that a distal end of the spring rests against the sleeve; forming a rim at a proximal end of the stem such that a proximal end of the spring rests against the rim; mounting a seal in the annular groove of the stem, wherein the stem is capable of sliding in a proximal direction until the seal contacts the sleeve; and mounting the check valve inside the tube such that the sleeve of the check valve is fixedly position within the tube.
EEE 11 is the method of EEE 10, wherein inserting the stem in the cylindrical cavity of the sleeve comprises: inserting a cylindrical portion of the stem in the cylindrical cavity of the sleeve, wherein the stem further includes a flanged distal end, wherein the annular groove is interposed between the cylindrical portion and the flanged distal end.
EEE 12 is the method of EEE 11, further comprising: forming the stem to have a blind cavity and one or more circumferential slots in the cylindrical portion.
EEE 13 is the method of EEE 12, wherein the sleeve comprises a tapered end, wherein mounting the check valve inside the tube comprises: inserting the sleeve into the tube, wherein the tapered end operates as a lead-in chamfer that facilitates insertion of the sleeve into the tube.
EEE 14 is the method of any of EEEs 11-13, further comprising: forming the flanged distal end of the stem such that an outer diameter of the flanged distal end is smaller than an inner diameter of the tube.
EEE 15 is the method of any of EEEs 10-14, wherein mounting the check valve inside the tube comprises: press fitting the sleeve into the tube.
EEE 16 is the method of any of EEEs 10-15, further comprising: forming an annular groove in a proximal end of the sleeve, wherein mounting the spring around the stem comprises causing a distal end of the spring to be received in the annular groove of the sleeve.
EEE 17 is the method of any of EEEs 10-16, wherein mounting the spring comprises: mounting a conical spring coiled in increasing outer diameter in a distal direction such that coils closer to the rim have a smaller diameter compared to coils closer to the sleeve.
EEE 18 is the method of any of EEEs 10-17, further comprising: after mounting the check valve within the tube, forming respective coupling features in a proximal end and a distal end of the tube to facilitate coupling the tube to a refrigeration system.
EEE 19 is the method of EEE 18, wherein forming the respective coupling features comprises using friction spinning to form the respective coupling features.
EEE 20 is the method of any of EEEs 18-19, wherein forming the respective coupling features comprises forming a neck at the proximal end of the tube.
EEE 21 is the method of any of EEEs 18-20, wherein forming the respective coupling features comprises forming threads at the proximal end of the tube.
EEE 22 is the method of any of EEEs 10-21, wherein forming the rim comprises: using a rolling forming process to form the rim.
EEE 23 is the method of any of EEEs 10-22, wherein the seal is a first seal, wherein the sleeve has an annular groove, and wherein the method further comprises: mounting a second seal in the annular groove of the sleeve such that the second seal is configured to seal between an exterior surface of the sleeve and an interior surface of the tube.
EEE 24 is the method of any of EEEs 10-23, wherein mounting the check valve inside the tube comprises: placing the sleeve at a particular axial position within the tube; forming a proximal annular groove in the tube on a proximal side of the sleeve; and forming a distal annular groove on a distal side of the sleeve, wherein the proximal annular groove and the distal annular groove form respective internal annular protrusions that retain the sleeve at the particular axial position within the tube.

What is claimed is:

1. An assembly comprising:
a tube having a first port and a second port;
a sleeve fixedly disposed within the tube;
a stem disposed, and axially movable, within the sleeve, wherein the stem has a rim formed at a proximal end thereof;
a spring mounted around the stem and axially interposed between the sleeve and the rim of the stem; and
a seal mounted to the stem, wherein:
refrigerant received at the first port pushes the stem in a distal direction, compressing the spring, thereby preventing the stem from moving in the distal direction beyond a particular axial position, while allowing refrigerant to flow to the second port, and
as pressure level at the first port is reduced, the spring pushes the stem in a proximal direction until the seal reaches the sleeve, thereby preventing the stem from moving further in the proximal direction, and blocking refrigerant flow to the first port.

2. The assembly of claim 1, wherein the stem has a cylindrical portion, a flanged distal end, and an annular groove interposed between the cylindrical portion and the flanged distal end, wherein the seal is mounted in the annular groove.

3. The assembly of claim 2, wherein the stem has a blind cavity and one or more circumferential slots formed in the cylindrical portion, wherein refrigerant received at the first port flows through the blind cavity, pushing the stem in the distal direction, then laterally outward through the one or more circumferential slots, then around the flanged distal end to the second port.

4. The assembly of claim 3, wherein the sleeve comprises a tapered end that facilitates inserting.

5. The assembly of claim 3, wherein an outer diameter of the flanged distal end is smaller than an inner diameter of the tube such that refrigerant discharged from the one or more circumferential slots flows through an annular gap formed between the flanged distal end and the tube.

6. The assembly of claim 1, wherein the sleeve has an annular groove formed in a proximal end of the sleeve, wherein a proximal end of the spring rests on the rim, while a distal end of the spring is received in the annular groove of the sleeve.

7. The assembly of claim 1, wherein the spring is a conical spring coiled in increasing outer diameter in the distal direction such that coils closer to the rim have a smaller diameter compared to coils closer to the sleeve.

8. The assembly of claim 1, wherein the seal is a first seal, wherein the sleeve has an annular groove, and wherein the assembly further comprises:
a second seal disposed in the annular groove of the sleeve such that the second seal is configured to seal between an exterior surface of the sleeve and an interior surface of the tube.

9. The assembly of claim 1, wherein the tube further comprises:
a proximal annular groove formed on a proximal side of the sleeve; and
a distal annular groove formed on a distal side of the sleeve, wherein the proximal annular groove and the distal annular groove form respective internal annular protrusions that retain the sleeve axially within the tube.

10. A method comprising:
providing a tube;
providing a sleeve of a check valve, wherein the sleeve has a cylindrical cavity;
inserting a stem in the cylindrical cavity such that the stem is axially movable within the sleeve, wherein the stem has an annular groove;
mounting a spring around the stem such that a distal end of the spring rests against the sleeve;
forming a rim at a proximal end of the stem such that a proximal end of the spring rests against the rim;
mounting a seal in the annular groove of the stem, wherein the stem is capable of sliding in a proximal direction until the seal contacts the sleeve; and
mounting the check valve inside the tube such that the sleeve of the check valve is fixedly position within the tube.

11. The method of claim 10, wherein inserting the stem in the cylindrical cavity of the sleeve comprises:
inserting a cylindrical portion of the stem in the cylindrical cavity of the sleeve, wherein the stem further includes a flanged distal end, wherein the annular groove is interposed between the cylindrical portion and the flanged distal end.

12. The method of claim 11, further comprising:
forming the stem to have a blind cavity and one or more circumferential slots in the cylindrical portion.

13. The method of claim 12, wherein the sleeve comprises a tapered end, wherein mounting the check valve inside the tube comprises:
inserting the sleeve into the tube, wherein the tapered end operates as a lead-in chamfer that facilitates insertion of the sleeve into the tube.

14. The method of claim 11, further comprising:
forming the flanged distal end of the stem such that an outer diameter of the flanged distal end is smaller than an inner diameter of the tube.

15. The method of claim 10, wherein mounting the check valve inside the tube comprises:
placing the sleeve at a particular axial position within the tube;
forming a proximal annular groove in the tube on a proximal side of the sleeve; and
forming a distal annular groove on a distal side of the sleeve, wherein the proximal annular groove and the distal annular groove form respective internal annular protrusions that retain the sleeve at the particular axial position within the tube.

16. The method of claim 10, further comprising:
forming an annular groove in a proximal end of the sleeve, wherein mounting the spring around the stem comprises causing a distal end of the spring to be received in the annular groove of the sleeve.

17. The method of claim 10, wherein mounting the spring comprises:
mounting a conical spring coiled in increasing outer diameter in a distal direction such that coils closer to the rim have a smaller diameter compared to coils closer to the sleeve.

18. The method of claim 10, further comprising:
after mounting the check valve within the tube, forming respective coupling features in a proximal end and a distal end of the tube to facilitate coupling the tube to a refrigeration system.

19. The method of claim 10, wherein the seal is a first seal, wherein the sleeve has an annular groove, and wherein the method further comprises:
mounting a second seal in the annular groove of the sleeve such that the second seal is configured to seal between an exterior surface of the sleeve and an interior surface of the tube.

20. The method of claim 10, wherein forming the rim comprises:
using a rolling forming process to form the rim.
